(19) United States
(12) Patent Application Publication
(10) Pub. No.: US 2008/0274650 A1
(43) Pub. Date: Nov. 6, 2008

(54) Accessory

(75) Inventors: Yoshio Segawa, Kanagawa (JP); Isao Sawachika, Kanagawa (JP); Fujio Nemoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 12/215,406

(22) Filed: Jun. 27, 2008

Related U.S. Application Data
(62) Division of application No. 11/905,200, filed on Sep. 28, 2007.
Application No. 11/905,200 is a division of application No. 11/294,390, filed on Dec. 6, 2005, now abandoned.

(30) Foreign Application Priority Data
Dec. 10, 2004 (JP) 2004-358417

(51) Int. Cl. H01R 24/00

(52) U.S. Cl. 439/660

(57) ABSTRACT

Disclosed is an accessory detachably mounted on an electronic device. The accessory includes a case, an electronic circuit housed in the case and activating the accessory, and an accessory's-side connector for supplying power to the electronic circuit or sending and receiving signals. The accessory's-side connector includes a portion of the case in which a plurality of leads is provided and a plurality of contact strips constructed such that a portion of the plurality of leads is exposed to the portion of the case. In the accessory, an intermediary substrate on which a wiring pattern is formed is provided inside the case; the plurality of leads is connected to the wiring pattern inside the case; an intermediary substrate's side connector connected to the wiring pattern is provided on the intermediary substrate; an electronic circuit's-side connector for connection to the electronic circuit is provided; and the electronic circuit and the accessory's-side connector are electrically connected when the electronic circuit's-side connector and the intermediary substrate's-side connector are connected.

### CROSS REFERENCES TO RELATED APPLICATIONS

The present invention contains subject matter related to Japanese Patent Application No. 2004-358417 filed in the Japanese Patent Office on Dec. 10, 2004, the entire contents of which being incorporated herein by reference.

### BACKGROUND OF THE INVENTION

1. Field of the Invention

The present invention relates to an accessory mounted on an electronic device and used.

2. Description of the Related Art

An image pick-up device (hereafter called an “electronic device”) like a digital camera and a video camera has, in most cases, an electronic device's-side connector for mounting accessories such as a flash unit for emitting auxiliary light and a microphone for collecting sounds. The electronic device's-side connector has contact strips for supplying power or for sending and receiving signals.

The accessory to be mounted on the electronic device has an accessory's-side connector to be attached to the electronic device's-side connector. The accessory's-side connector has contact strips for supplying power or for sending and receiving signals to be connected to the electronic device's-side contact strips for supplying power or for sending and receiving signals.

As an accessory described above, the one having a case and an electronic circuit to activate the accessory housed in the case is proposed, wherein each one end of a plurality of leads of contact strips of the accessory's-side connector is exposed to a portion of the case where a plurality of leads is provided (see Japanese Patent No. 3500845).

In the accessory, the other end of the lead is detachably joined to a connector, and the connector is connected to components of a flash unit or a microphone through a plurality of wires.

### SUMMARY OF THE INVENTION

In recent years, since accessories have become multifunctional, the number of signals sent and received between such accessories and electronic devices is increasing and hence the number of contact strips of the accessory's-side connector is increasing. Therefore, contact strips in large numbers have to be provided in a limited space, and distances between each of the contact strips as well as between each of the leads are shortened.

On the other hand, a connector attached to the other end of the lead is constructed in such a way that wires are connected inside the accessory by compression bonding or soldering. Therefore, such a construction cannot be made available when the distances between the contact strips and between the leads are shortened, and the conventional accessory cannot sufficiently cope with increase in the number of the contact strips of the accessory's-side connector.

In view of the above, there is a need for providing an accessory which has an advantage in coping with the increase in the number of signals sent and received between the accessory and the electronic device.

According to an embodiment of the present invention, there is provided an accessory detachably mounted on an electronic device. The accessory includes a case, an electronic circuit housed in the case and activating the accessory and an accessory's-side connector for supplying power to the electronic circuit or for sending and receiving signals. The accessory's-side connector has a portion of the case in which a plurality of leads is provided and a plurality of contact strips constructed such that a portion of the plurality of leads is exposed to the portion of the case. An intermediary substrate on which a wiring pattern is formed is provided in the case. The plurality of leads and the wiring pattern are connected in the case. An intermediary substrate's-side connector connected to the wiring pattern is provided on the intermediary substrate. An electronic circuit's-side connector for connection to the electronic circuit is provided. Finally, the electronic circuit's-side connector and the intermediary substrate's-side connector are connected so that the electronic circuit and the accessory's-side connector are electrically connected.

According to an embodiment of the present invention, the portion of the intermediary substrate where the intermediary substrate's-side connector is provided is away from the contact strips of the accessory's-side connector. Therefore, the space of the intermediary substrate occupied by the intermediary substrate's-side connector can sufficiently be secured. Thus, even if numbers of contact strips are provided in a limited space, the electronic circuit of the accessory and the contact strips can reliably be connected, which is advantageous for coping with the increase in the number of signals sent and received between the accessory and electronic devices.

### BRIEF DESCRIPTION OF THE DRAWINGS

Embodiments of the present invention will be described in detail based on the following figures, wherein:

FIG. 1 is a perspective view, seen from the front, of a video camera 100 on which an accessory of a first embodiment is mounted;

FIG. 2 is a perspective view of an electronic device's-side connector provided in the video camera 100 in which a shutter of the electronic device's-side connector is closed;

FIG. 3 is a perspective view of the electronic device's-side connector provided in the video camera 100 in which the shutter of the electronic device's-side connector is opened;

FIG. 4 shows a construction of the electronic device's-side connector, wherein FIG. 4(A) is a plan view of the electronic device's-side connector; FIG. 4(B) is a view taken in the direction of arrow B of FIG. 4(A); FIG. 4(C) is a view taken in the direction of arrow C of FIG. 4(A); and FIG. 4(D) is a view taken in the direction of arrow D of FIG. 4(A);

FIGS. 5E and 5F show constructions of the electronic device's-side connector, wherein FIG. 5E is a view taken in the direction of arrow E of FIG. 4(D) and FIG. 5F is a cross section taken along line F-F of FIG. 5E;

FIG. 6 is a perspective view of the accessory;

FIG. 7 is a perspective view of an accessory's-side connector provided in the accessory;

FIG. 8 is a plan view of the accessory's-side connector;

FIG. 9 is a view taken in the direction of arrow A of FIG. 7;

FIG. 10 is a view taken in the direction of arrow B of FIG. 8;

FIG. 11 is a cross section taken along line C-C of FIG. 9;

FIG. 12 is a cross section showing a state in which the accessory's-side connector is inserted into the electronic device's-side connector;

FIG. 13 is a cross section showing a state in which the accessory's-side connector is attached to the electronic device's-side connector;

FIG. 14 is a perspective view showing a state in which the accessory's-side connector is positioned above the electronic device's-side connector;

FIG. 15 is a view taken in the direction of arrow A of FIG. 14;

FIG. 16 is a perspective view showing a state in which the accessory's-side connector is attached to the electronic device's-side connector;

FIG. 17 is a view taken in the direction of arrow A of FIG. 16;

FIG. 18 is an illustration of a construction of the accessory's-side connector 40; and

FIG. 19A is a plan view showing one face of the intermediary substrate and FIG. 19B is a plan view showing the other face of the intermediary substrate.

### DESCRIPTION OF THE PREFERRED EMBODIMENTS

The present inventors have recognized the problem described above, and according to embodiments of the present invention, an intermediary substrate on which a wiring pattern is formed is provided in a case, a plurality of leads and the wiring pattern are connected in the case, an intermediary substrate's-side connector connected to the wiring pattern is provided in the intermediary substrate, an electronic circuit's-side connector to be connected to an electronic circuit is provided, and the electronic circuit's-side connector and the intermediary substrate's-side connector are connected.

### First Embodiment

Now, referring to the drawings, a first embodiment of the present invention will be described.

First, an electronic device on which an accessory of the present invention is mounted will be described. In the present embodiment, the electronic device is a video camera 100.

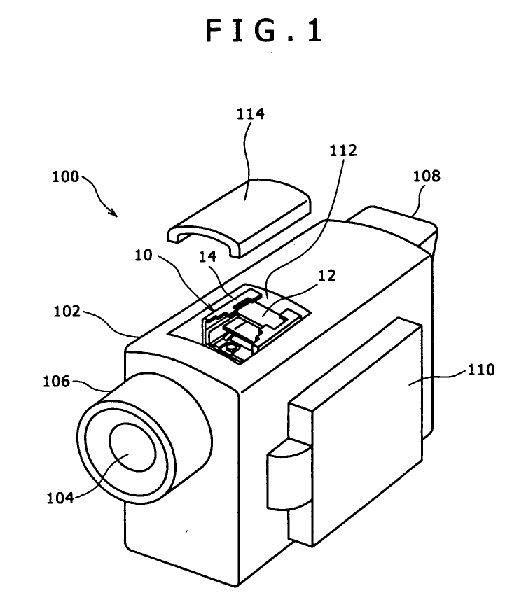

FIG. 1 is a perspective view, seen from the front, of the video camera 100 on which an accessory of the first embodiment is mounted.

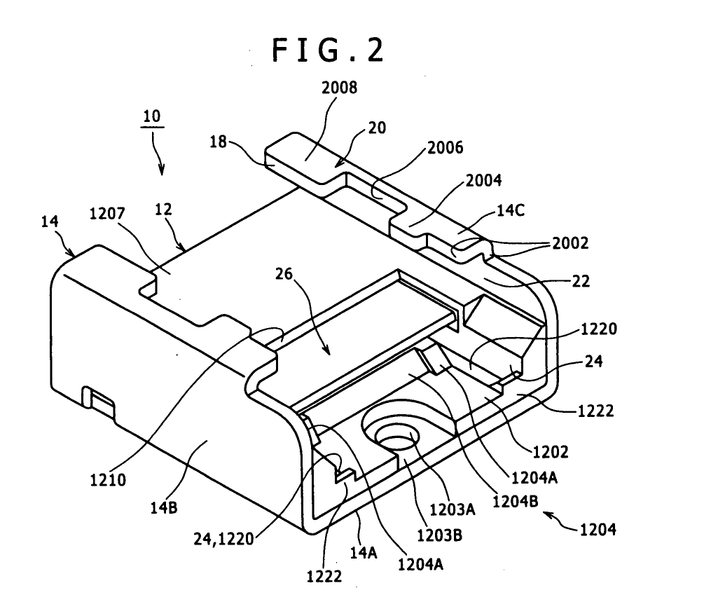

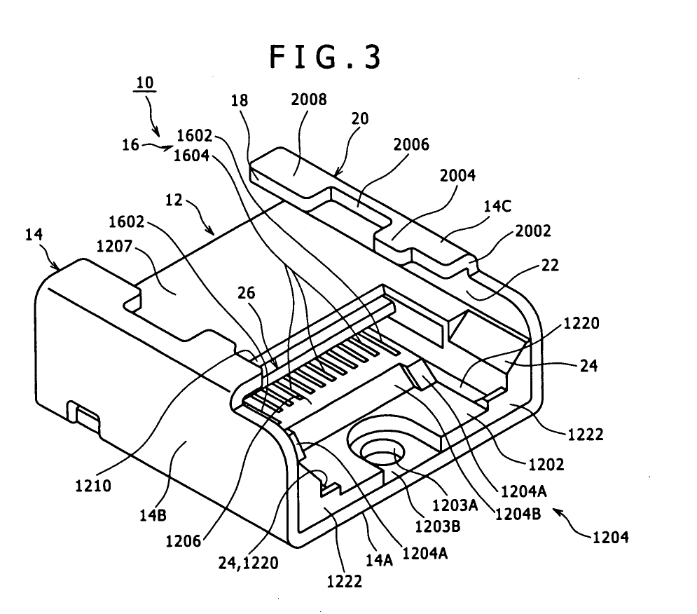

FIG. 2 is a perspective view of the electronic device's-side connector provided in the video camera 100 in which a shutter of the electronic device's-side connector is closed, and FIG. 3 is a perspective view of the electronic device's-side connector provided in the video camera 100 in which the shutter of the electronic device's-side connector is opened.

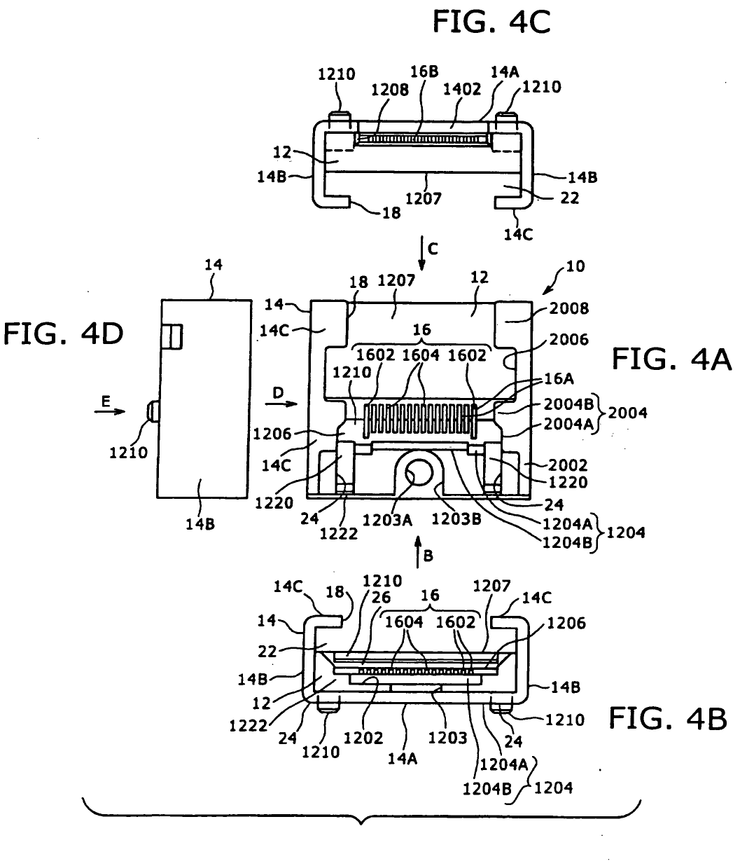

FIG. 4(A) is a plan view of the electronic device's-side connector; FIG. 4(B) is a view taken in the direction of arrow B of FIG. 4(A); FIG. 4(C) is a view taken in the direction of arrow C of FIG. 4(A); and FIG. 4(D) is a view taken in the direction of arrow D of FIG. 4(A).

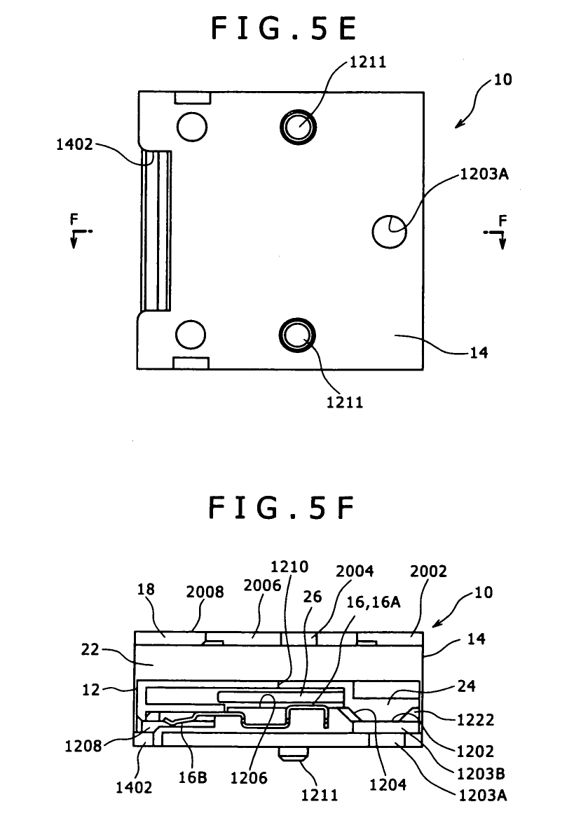

FIG. 5E is a view taken in the direction of arrow E of FIG. 4(D); and FIG. 5F is a cross section taken along line F-F of FIG. 5E.

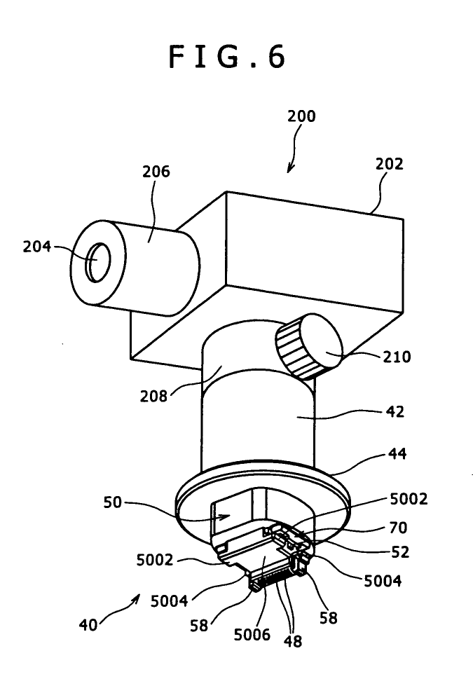

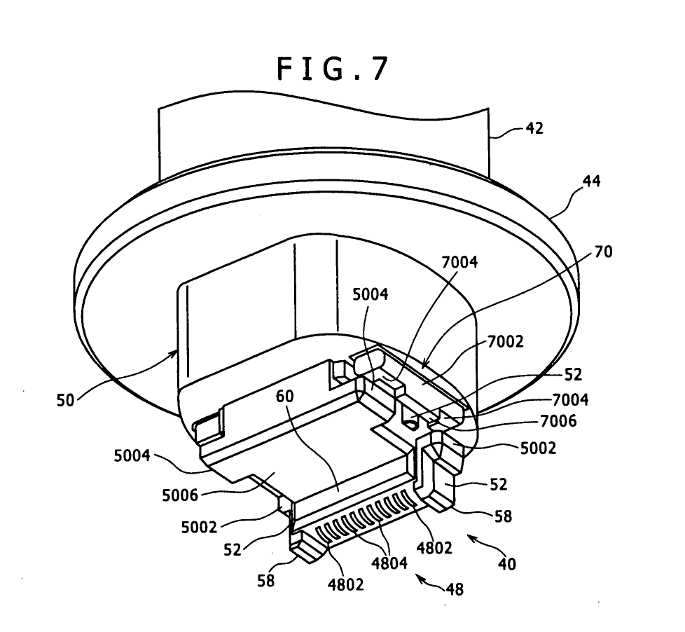

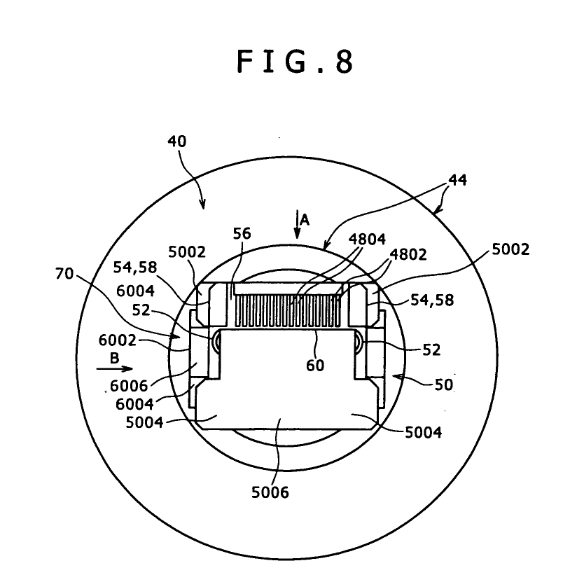

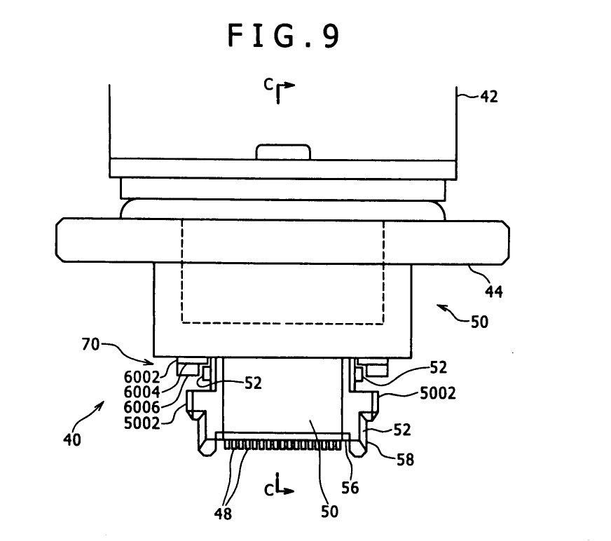

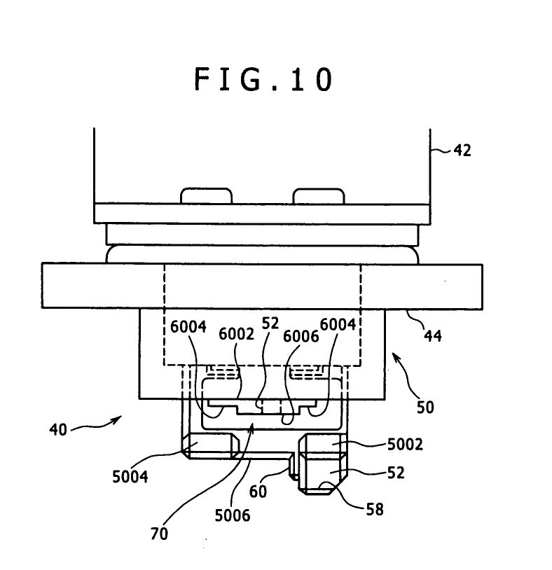

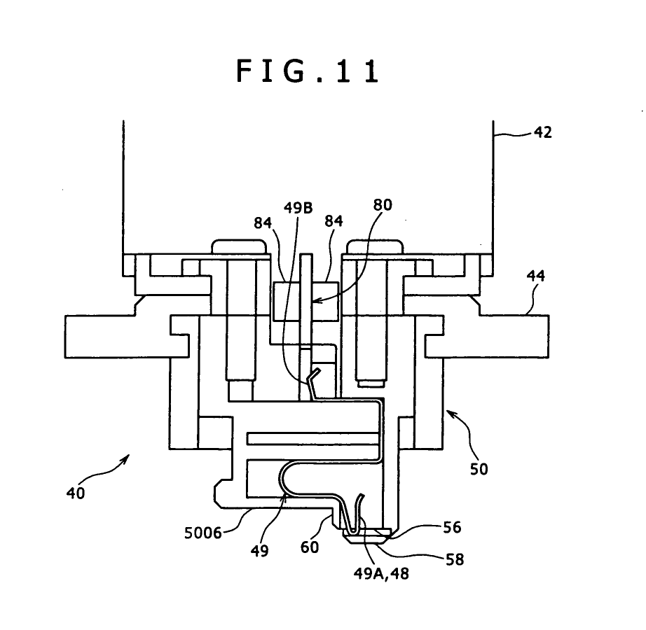

FIG. 6 is a perspective view of the accessory; FIG. 7 is a perspective view of an accessory's-side connector provided in the accessory; FIG. 8 is a plan view of the accessory's-side connector; FIG. 9 is a view taken in the direction of arrow A of FIG. 7; FIG. 10 is a view taken in the direction of arrow B of FIG. 8; and FIG. 11 is a cross section taken along line C-C of FIG. 9.

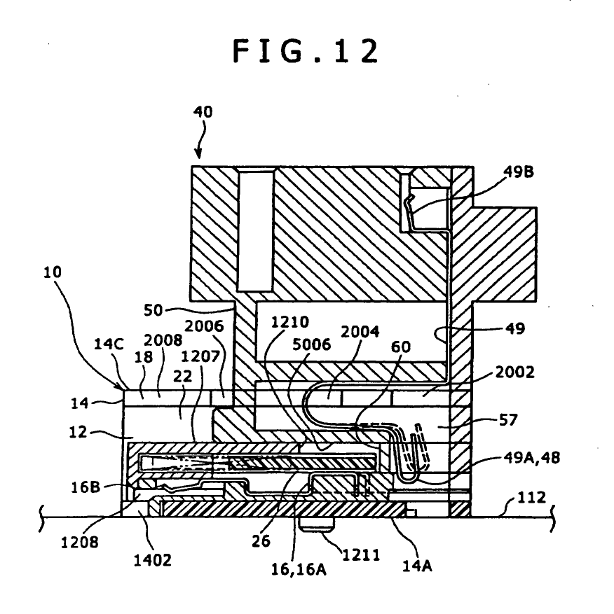

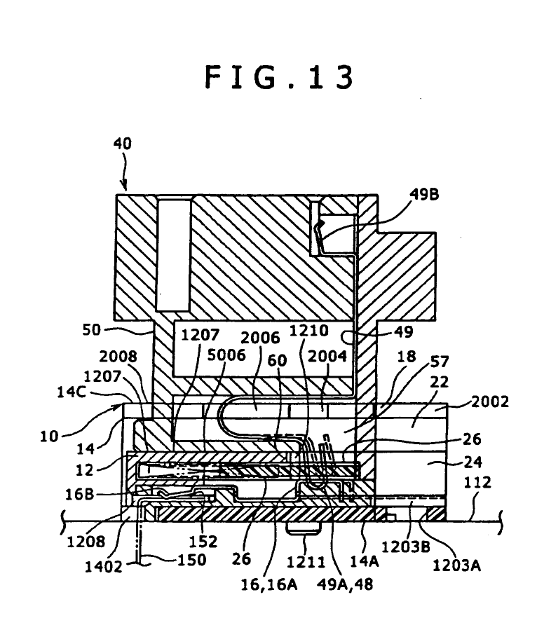

FIG. 12 is a cross section showing a state in which the accessory's-side connector is inserted into the electronic device's-side connector, and FIG. 13 is a cross section showing a state in which the accessory's-side connector is attached to the electronic device's-side connector.

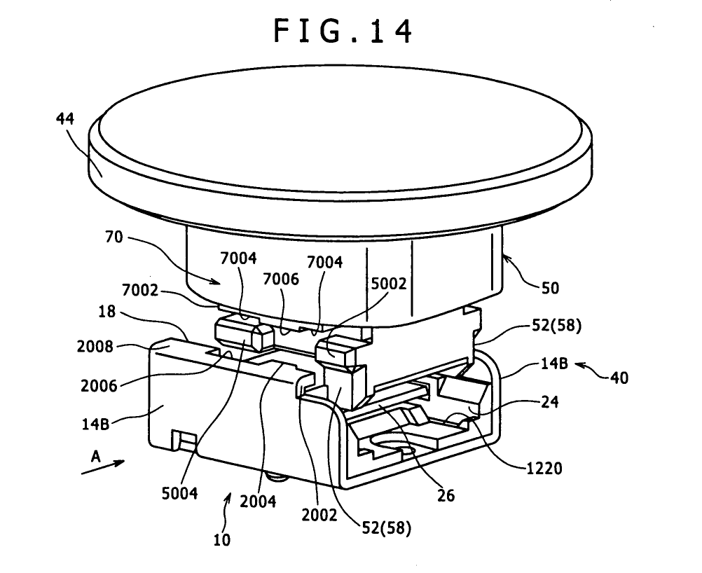

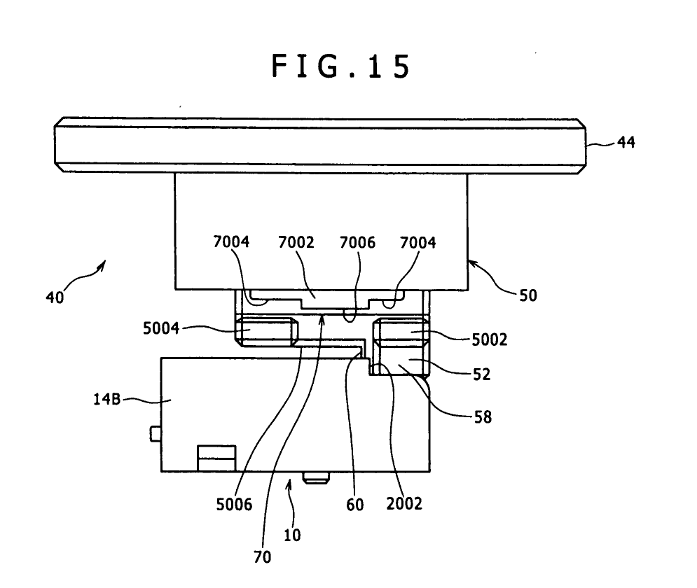

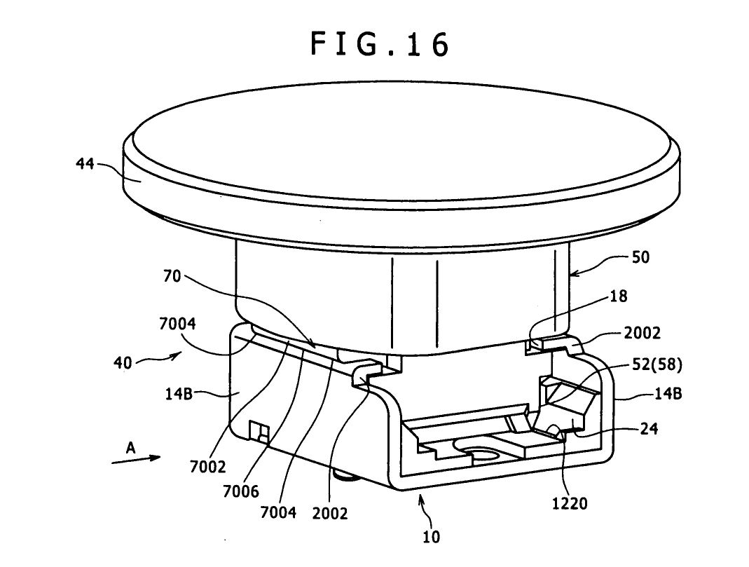

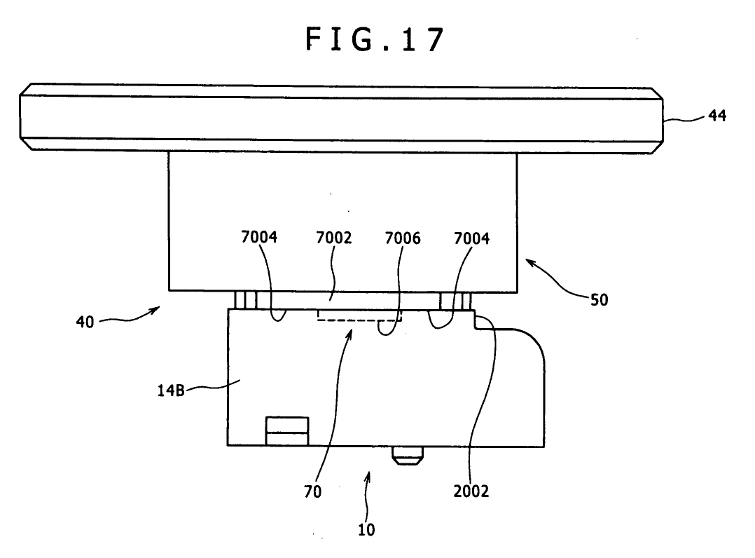

FIG. 14 is a perspective view showing a state in which the accessory's-side connector is positioned above the electronic device's-side connector; FIG. 15 is a view taken in the direction of arrow A of FIG. 14; FIG. 16 is a perspective view showing a state in which the accessory's-side connector is attached to the electronic device's-side connector; and FIG. 17 is a view taken in the direction of arrow A of FIG. 16.

As shown in FIG. 1, the video camera 100 in the present embodiment is a video camera, and has a rectangular case 102. In the present specification, right and left are defined when seen from the front of the video camera 100. Further, the subject's side of the optical system in the axial direction is referred to as a front side and the image pick-up device's side is referred to as a rear side.

On the upper portion of the front side of the case 102, a lens barrel 106 in which the picture-taking optical system 104 is incorporated is provided facing forward.

In the case 102, there are housed the image pick-up device imaging a subject guided by the picture-taking optical system 104, a recording and reproducing unit recording and reproducing images of still pictures and moving pictures of the subject imaged by the image pick-up device etc. are housed.

On the upper portion of the rear side of the case 102, an electronic finder 108 for viewing a subject image imaged by the image pick-up device is provided.

On the right side of the case 102, a display 110 for showing a subject image etc. imaged by the image pick-up device is provided in such a way that it can be opened or closed freely.

On the upper portion of the rear side and left side of the case 102, operation switches (not shown) such as a start/stop switch for picture taking and a configuration switch (not shown) for various settings are provided.

In the front portion of the upper surface of the case 102, a concave portion 112 which is rectangular as seen from the above is provided. On the concave portion 112, a lid 114 for covering the concave portion 112 is detachably attached. An electronic device's-side connector 10 is provided in the concave portion 112. When the electronic device's-side connector 10 is not in use, the electronic device's-side connector 10 is covered by the lid 114 being attached to the concave portion 112. When the electronic device's-side connector 10 is in use, the electronic device's-side connector 10 is exposed to the outside by detaching the lid 114 from the concave portion 112.

On the video camera 100, an accessory 200 (See FIG. 6) to be described later is mounted via the electronic device's-side connector 10.

Now, the electronic device's-side connector 10 will be described.

As shown in FIGS. 2 and 3, the electronic device's-side connector 10 includes an inner member 12 integrally molded by using synthetic resin and an outer member 14 which is formed by bending a steel plate. The inner member 12 is fitted into an inner lower portion of the outer member 14 and fixed there.

The outer member 14 includes a base plate 14A, side plates 14B erected from both the sides of the base plate 14A, and a pair of upper plates 14C being bent from the upper edges of the side plates 14B so as to be opposed to each other.

The electronic device's-side connector 10 includes contact strips 16 for supplying power or sending and receiving signals, a pair of latch plates 20, a guide groove 18 formed between the pair of opposing latch plates 20, and a void space 22 provided facing an undersurface of each latch plate 20.

The pair of latch plates 20 is formed as part of the pair of upper plates 14C, extends on the same plane, and their edges are opposed to each other.

The guide groove 18 is formed in an extended manner between the edges of the pair of opposing latch plates 20 in the direction perpendicular to the direction in which the latch plates 20 are opposed to each other, and both the ends in the extending direction are opened.

At the edges of the latch plates 20 opposed to each other, there are provided first concave portions 2002 recessed in the direction in which the pair of opposing latch plates 20 become distant from each other (or cut-away portions 2002 where latch plates 20 are cut away), first convex portions 2004 protruding in the direction in which the edges of the opposing latch plates 20 become close, second concave portions 2006 recessed in the direction in which the edges of the pair of opposing latch plates 20 become distant from each other, and second convex portions 2008 protruding in the direction in which the edges of the opposing latch plates 20 become close in that order in the direction in which the guide groove 18 extends.

The top edge of each first convex portion 2004 and the top edge of each second convex portion 2008 extend linearly in parallel with the direction in which the guide groove 18 extends. As shown in FIG. 4(A), the first convex portion 2004 is constructed such that a convex portion 2004A whose protruding size is smaller and a convex portion 2004B whose protruding size is larger are aligned in the extending direction of the guide groove 18. The protruding size of the second convex portion 2008 is the same as that of the convex portion 2004B.

The void space 22 is a space where the accessory's-side connector 40 (See FIG. 6) is inserted and moved in the direction perpendicular to the inserting direction, which is below the latch plates 20, inside both the side plates 14B, and above the inner member 12.

Further, for the sake of convenience in the description of the embodiments, when attaching the accessory's-side connector 40 to the electronic device's-side connector 10, the direction in which the accessory's-side connector 40 is inserted into the void space 22 through the guide groove 18 is called an inserting direction. Further, the direction in which the accessory's-side connector 40 is moved in the void space 22 after the insertion of the accessory's-side connector 40 into the void space 22, namely, the direction in which the guide groove 18 extends is called a mounting direction. Still further, the reverse direction of the inserting direction is called a removing direction, and the reverse direction of the mounting direction is called a detaching direction.

At the portion of the electronic device's-side connector 10 forming a bottom portion of the void space 22, namely, a portion of the inner member 12 below the first concave portion 2002 and the first convex portion 2004, a pair of connector's-side guide face 24 opposed with each other in the width direction of the guide groove 18 and extending in the mounting direction are provided. The pair of connector's-side guide faces 24 defines the position of the accessory's-side connector 40 in the direction perpendicular to the extending direction of the guide groove 18, namely, in the width direction of the guide groove 18.

As shown in FIG. 3, a plurality of contact strips 16 of the electronic device's-side connector 10 is provided at the bottom of the void space 22 and at a portion of the inner member 12 between the pair of connector's-side guide faces 24.

To describe in detail, at the portion of the inner member 12 forming a bottom portion of the void space 22 between the pair of connector's-side guide faces 24, there are provided a bottom face 1202, a slope 1204 gradually erecting from the edge portion of the bottom face 1202, a flat contact-strip attaching face 1206 extending from the edge portion of the slope 1204 in parallel with the bottom face 1202. The bottom face 1202, slope 1204, and contact-strip attaching face 1206 are arranged one by one along the mounting direction.

Further, at the portion of the inner member 12 below the second concave portion 2006 and the second convex portion 2008, a flat intermediate face 1207 in parallel with the bottom face 1202 is provided. This intermediate face 1207 extends on a portion of the inner member 12 below the first concave portion 2002 and the first convex portion 2004 and along both the side plates 14B.

In the present embodiment, when the accessory's-side connector 40 is inserted into the void space 22, a top face 5006 (See FIG. 7) of the accessory's-side connector 40 contacts the intermediate surface 1207 so that the position of the accessory's-side connector 40 in the inserting direction in the void space 22 is defined, namely, the positioning is made.

Then, the contact strips 16 of the electronic device's-side connector 10 are aligned on the contact-strip attaching face 1206 at intervals along the width direction of the guide groove 18 from the border portion between the slope 1204 and the contact strip-attaching face 1206 in the mounting direction.

Now, the plurality of contact strips 16 of the electronic device's-side connector 10 will be described in detail. As shown in FIG. 5F, a plurality of leads 15, each of which is a metal strip, is provided in the case. A portion of such a lead 15 serves as each contact strip 16.

One end of each lead 15 is exposed to the space above the contact strip-attaching face 1206 through an opening as a contract strip 16. As shown in FIG. 4(A), the contact strips 16 are aligned with their longitudinal directions coinciding with the mounting direction.

As shown in FIG. 4(A), the contact strips 16 of the electronic device's-side connector 10 are arranged so that ends thereof in the mounting direction are positioned linearly in the width direction of the guide groove 18. Of the plurality of contact strips 16, ground contact strips 1602 to be connected to ground are so formed as to be of larger longitudinal sizes compared to other signal contact strips 1604. Ends of the ground contact strips 1602 in the detaching direction protrude more than ends of other signal contact strips 1604 do.

Such a layout of the contact strips 1602 and 1604 is made for the purpose of reducing the effect of an electrostatic noise and stabilizing the workings of the accessory and electronic device when attaching accessory's-side connector 10, as shown in FIG. 7, by connecting ground contact strips 4802 of the accessory's-side connector 40 to the ground contact strips 1602 of the electronic device s-side connector 10 ahead of other signal contact strips 4804 and allowing the reference potential of the accessory 200 and video camera 100 to be at a ground potential first.

Further, in the present embodiment, two ground contact strips 1602 are provided at both the ends of the plurality of contact strips 16 in the width direction of the guide groove 18.

Such a layout of the contact strips 1602 and 1604 is made for the purpose of allowing the reference potential of the accessory 200 and video camera 100 to be at a ground potential more reliably, reducing the effect of an electrostatic noise, and further stabilizing the workings of the accessory and electronic device even when the accessory's-side connector 40 is inserted in a tilted way with respect to the direction in which the guide groove 18 extends, by one of the ground contact strips 1602 on both the ends in the width direction contacting one of the ground contact strips 4802 (See FIG. 7) of the accessory's-side connector 40 corresponding the ground contact strips 1602.

Further, as shown in FIG. 5F, the lead 15 portion other than the portion serving as a contact strip 16 is placed inside the inner member 12, and the other end of the lead 15 is guided into the hole 1208 opened at the edge of the inner member 12 in the mounting direction.

As shown in FIG. 4(C), FIG. 5E, and FIG. 5F at the bottom of the inner member 12 and the bottom plate 14A of the outer member 14, a cutaway portion 1402 is provided so as to be in communication with the hole 1208. Further, as shown in FIG. 13, a connection end 152 of a flexible substrate 150 provided in the video camera 100 is inserted into the hole 1208 through the cutaway portion 1402 and, inside the hole 1208, the connection end 152 is electrically connected to the other end of each contact strip 16. Also, by the elasticity of each of other ends, the connection end 152 is held between each of the other ends and a wall in which the hole 1208 is made.

Accordingly, electric signals for driving the accessory 200 are supplied to each contact strip 16 from the electronic circuit inside the video camera 100 through the flexible substrate 150 or electric signals from the accessory 200 are supplied to the electronic circuit inside the video camera 100 through each contact strip 16.

In this regard, as shown in FIG. 13, when the bottom plate 14A of the outer member 14 is attached to the bottom face of the concave portion 112 of the video camera 100, since the cutaway portion 1402 is made in the outer member 14, the flexible substrate 150 can be bent in the cutaway portion 1402 and be guided into the video camera 100.

Therefore, as seen from the above, the flexible substrate 150 is positioned inside the outline of the outer member 14, namely, inside the outline of the electronic device's-side connector 10. Accordingly, there is no need to secure space for laying the flexible substrate 150 outwardly of the electronic device-side connector 10, which is advantageous for reducing the space necessary for mounting the electronic device's-side connector 10.

Further, in FIG. 5F, the reference numeral 1211 denotes a boss protruding from the bottom face of the outer member 14. The accessory's-side connector 40 is positioned by having the boss 1211 engage with the hole made in the bottom of the concave portion 112 (See FIG. 1) of the video camera 100.

In the present embodiment, as shown in FIG. 3, the slope 1204 includes a slope 1204A corresponding to a contact strip 1602 connected to ground and a slope 1204B corresponding to the other contact strip 1604. A difference in level is made between the slope 1204A and the slope 1204B. This is because, since an insertion hole 1203A through which a thread is inserted to attach the electronic device's-side connector 10 to the bottom of the concave portion 112 of the image pick-up device 100 and a concave portion 1203B to house a head of the thread are formed in the bottom face 1202 near the slope 1204B, the position of the slope 1204B is shifted in the mounting direction with respect to the position of the slope 1204A so as to avoid the concave portion 1203B.

The slope 1204 serves to guide the contact strips 48 of the accessory's-side connector 40 smoothly.

The contact strips 16 are provided on the contact-strip attaching face 1206 spaced from the border portion between the slope 1204 and the contact-strip attaching face 1206 in the mounting direction. This is because, when the accessory's-side connector 40 is inserted into the electronic device's-side connector 10 and is moved in the mounting direction, the contact strips 48 of the accessory's side-connector 40 are allowed to be in contact stably with the contact strips 16 by the contact strips 48 of the accessory's side-connector 40 being slidably in contact with the contact-strip attaching face 1206 as much as the above spaced portions. Therefore, on the contact-strip attaching face 1206, the region from the border portion between the slope 1204 and the contact-strip attaching face 1206 to the ends of the contact strips 16 in the detaching direction serves as a sliding surface for the contact strips 48 of the accessory's side-connector 40.

Further, at the portion of the inner member 12 forming the bottom of the void space 22 which is between the pair of connector's-side guide surfaces 24, to be specific, below the intermediate face 1207, a cover 26 for covering the contact strips 16 of the electronic device's-side connector 10 is provided movably in the mounting direction.

Then, a spring (not shown) to urge the cover 26 toward a close position (See FIGS. 2 and 12) for covering the contact strips 16 of the electronic device's-side connector 10 is provided. The cover 26 is so constructed as to come in contact with the erected face 60 (See FIG. 7) which is a portion of the shaft unit 50 of the accessory's-side connector 40 when moved in the mounting direction and further moved to a release position (See FIGS. 3 and 13) for releasing the contact strips 16 by the shaft unit 50.

Further, at the end of the intermediate face 1207 in the detaching direction, a contact face 1210 is formed, extending along the width direction of the guide groove 18.

In the present embodiment, when the accessory's-side connector 40 is inserted into the void space 22, the erected face 60 (See FIG. 7) of the accessory's-side connector 40 comes in contact with the contact face 1210 so that the position of the accessory's-side connector 40 in the mounting direction is restricted, or defined, in the void space 22.

As shown in FIGS. 2 and 3, concave portions 1220 extending along the connector's-side guide faces 24 are provided at portions of both the sides in the width direction of the guide groove 18. Tips of the guide walls 58 (See FIG. 7) are housed in the concave portion 1220 when the accessory's-side connector 40 is inserted.

At the end of the concave portion 1220 in the detaching direction, a wall 1222 to close the end of the concave portion 1220 in the detaching direction is provided. An upper face of the wall 1222 and the bottom face 1202 are on the same plane.

Accordingly, even when inserting the shaft unit 50 (See FIG. 7) of the accessory's-side connector 40 in the mounting direction from the portion facing in the detaching direction of the electronic device's-side connector 10, the guide walls 58 of the shaft unit 50 contact against the walls 1222 and the insertion in the mounting direction is prohibited.

Therefore, erroneous operations such as inserting the shaft unit 50 of the accessory's-side connector 40 reversely can be prohibited.

Thus, when attaching the accessory's-side connector 40 to the electronic device's-side connector 10, the insertion of the accessory's-side connector 40 into the void space 22 between the guide grooves 18 alone is allowed. Therefore, the way to mount the accessory 200 on the video camera 100 can be limited to one, the usability thereof being improved.

Now, the accessory 200 will be described.

As shown in FIG. 6, in the present embodiment, the accessory 200 is a small-sized camera compared to the video camera 100. In addition to picture taking by the video camera 100, this small-sized camera also can take pictures of a subject in the direction different from that of the video camera 100 and can take pictures of the same or different subject of the video camera 100 by the ratio of image different from that of the video camera 100.

The accessory 200 has a case 202 of a rectangular solid serving as an armor. On the front of the case 202, a lens barrel 206 in which picture-taking optical system 204 is incorporated is provided facing forward.

In the case 202, there are housed an image pick-up device for picking up images of the subject guided by the picture-taking optical system 204, and an electronic circuit including a signal processor etc. processing the picked-up image signals produced by the image pick-up device and outputting them to the accessory's-side connector 40 to be described later.

On the undersurface of the case 202, a cylindrical joint 208 protruding downward is provided integrally with the case 202.

As shown in FIG. 6, provided underneath the joint 208 is a cylindrical shaft member 42 rotatably connected coaxially with the joint 208. The reference numeral 210 denotes a clamp screw locking the rotation of the shaft member 42 with respect to the joint 208.

As shown in FIG. 7, at the tip (lower end) of the shaft member 42 in its longitudinal direction, there is provided a shaft unit 50 in the shape of a prism whose cross section is smaller than that of the shaft member 42 and which extends coaxially with the shaft member 42. The accessory's-side connector 40 is provided on the shaft unit 50.

The shaft unit 50 is made of non-conducting synthetic resin.

Side faces of both the sides of the top of the shaft unit 50 are formed slightly smaller in size than the size between the tips of the pair of first convex portions 2004 forming the most inner-side periphery of the guide groove 18 and the size between the tips of the pair of second convex portions 2008 so that they can smoothly be inserted in and removed from the guide groove 18.

On the side faces of both the sides of the tip of the shaft unit 50, there are provided a first latch piece 5002 inserted into the void space 22 from a first concave portion 2002 of the electronic device's-side connector 10 and being movable along the mounting direction and a second latch piece 5004 inserted into the void space 22 from a second concave portion 2006 of the electronic device's-side connector 10 and being movable along the mounting direction, protruding and spaced from each other.

In the present invention, the length of extension of the first and second latch pieces 5002 and 5004 in the mounting direction is about one third of the size of the shaft unit 50 in the mounting direction.

As shown in FIGS. 9 to 11, at the portions on the side faces of both the sides of the tip of the shaft unit 50 and between the first and the second latch pieces 5002 and 5004, spring pieces 52 protrude in a bent manner. The spring pieces 52 are provided by incorporating spring steel sheets into the shaft unit 50.

The spring piece 52 is provided at a position closer to the base of the shaft unit 50 than the first and the second latch pieces 5002 and 5004 are. The spring piece 52 is positioned inside the first concave portion 2002 when the first latch piece 5002 is positioned in the void space 22 after passing through the first concave portion 2002 and the second latch piece 5004 is positioned in the void space 22 after passing through the second concave portion 2004. Further, the spring piece 52 comes elastically in contact with the tip of the first convex portion 2004 when the first and second latch pieces 5002 and 5004 move in the direction of the undersurface of the first and the second convex portions 2004 and 2008 in the void space 22. Still further, the spring piece 52 is positioned in the second concave portion 2008 when the first and second latch pieces 5002 and 5004 are on the undersurfaces of the first and second convex portions 2004 and 2008. The spring pieces 52 are so constructed as to give a click-like feeling to a user when the accessory 200 is mounted. According to the present embodiment, in the void space 22, when the first and the second latch pieces 5002 and 5004 move in the mounting direction to be positioned on the undersurfaces of the first and second convex portions 2004 and 2008, the first and second latch pieces 5002 and 5004 come in contact elastically with the edge portion of the second concave portion 2006 closer to the first convex portion 2004 and tentatively latch the accessory 200 there.

Further, a top face 5006 is provided at the top of the shaft unit 50, and the top face 5006 comes in contact with the intermediate face 1207 of the electronic device's-side connector 10 when the shaft unit 50 is inserted into the void space 22 so that the position of the accessory's-side connector 40 is restricted, namely, the positioning is made in the inserting direction in the void space 22.

In the present embodiment, the pair of guide walls 58 is formed in a protruding manner from the base edges of the first latch pieces 5002 on both the sides in the longitudinal direction (the inserting direction) of the shaft unit 50 so as to be opposed with each other. Outer sides of the pair of guide walls 58 are formed as accessory guide faces 54 slidable on a pair of connector's-side guide faces 24. The positioning of the accessory's-side connector 40 in the width direction of the guide groove 18 in the void space 22 is made when the accessory guide faces 54 come in contact with the connector's-side guide faces 24.

Further, in the present embodiment, when the shaft unit 50 of the accessory's-side connector 40 is inserted into the void space 22 of the electronic device's-side connector 10, if the shaft unit 50 is inserted reversely along the mounting direction, the pair of guide walls 58 of the accessory's-side connector 40 come in contact with the intermediate face 1207 of the electronic device's-side connector 10 and the insertion in a reversed way is prohibited.

On the top of the shaft unit 50 and between the base portions of the pair of guide walls 58, a flat contact-strip attaching face 56 is provided in parallel with the top face 5006. The contact-strip attaching face 56 is located closer to the tip than the top face 5006 is, and there is formed between the contact-strip attaching face 56 and the top face 5006 an erected face 60 perpendicular to the faces 56 and 5006.

The contact strips 48 of the accessory's side-connector 40 is provided on the contact-strip attaching face 56, and are arranged linearly at intervals in the direction of the pair of guide walls 58.

The erected face 60 is so constructed as to come in contact with the end face of the cover 26 when the shaft unit 50 is inserted into the void space 22 of the electronic device's-side connector 10 and moved in the mounting direction

Further, when the shaft unit 50 is inserted into the void space 22 of the electronic device's-side connector 10 and is moved in the mounting direction in the void space 22, the first and second latch pieces 5002 and 5004 are positioned on the undersurfaces of the first and second convex portions 2004 and 2008. In this state, the plurality of contact strips 48 of the accessory's-side connector 40 comes in contact with the plurality of contact strips 16 of the electronic device's-side connector 10.

Then, from the video camera 100 through these contact strips 16 and 48, an electric signal for driving the accessory 200 is supplied to the electronic circuit inside the accessory 200, or an electric signal from the electronic circuit inside the accessory 200 is supplied to the video camera 100 through the contact strips 16 and 48.

With the tip of the shaft unit 50 being inserted in the guide groove 18, at the portion of the shaft unit 50 above the latch plate 20, an operating ring 44 in the shape of a ring is rotatably provided. In the present embodiment, a groove is provided between the shaft member 42 and the shaft unit 50, and the operating ring 44 is rotatably placed in the groove.

On both the sides of the shaft unit 50, a fastening block 70 movable in the longitudinal direction of the shaft unit 50, namely, movable in the vertical direction, by the rotating operation of the operating ring 44 is provided.

The fastening block 70 includes a vertical plate 7002, a fastening part 7004, and a move-prohibiting part 7006. The vertical plate 7002 extends in parallel with the direction in which the shaft unit 50 extends. The fastening part 7004 is provided at the lower end of the vertical plate 7002, and comes in contact with the top faces of the first and second convex portions 2004 and 2008 when the first and second latch pieces 5002 and 5004 are in contact with the undersurfaces of the first and second convex portions 2004 and 2008 and, in collaboration with the first and second latch pieces 5002 and 5004, fastens the first and second convex portions 2004 and 2008. The move-prohibiting member 7006 is inserted into the second concave portion 2006 between the first and second convex portions 2004 and 2008, and prohibits the shaft unit 50 from moving along the direction in which the guide groove 18 extends.

The fastening part 7004 is a rectangular solid which has longer sides in the direction in which the guide groove 18 extends and has a cross section larger in size than that of the vertical plate 7002.

The move-prohibiting part 7006 is expanded to be formed in a shape of a rectangular solid from the undersurface of the fastening part 7004, and is formed with a size that can allow the move-prohibiting part 7006 to be inserted between the first and second convex portions 2004 and 2008, namely, to be inserted in the second concave portion 2006.

Further, the fastening block 70 can be implemented by various conventional mechanisms and constructions such as by inserting the vertical plate 7002 into the concave portion provided in the shaft unit 50 in such a ways that it is movable only in the longitudinal direction of the shaft unit 50, and by having the female thread on the inner surface of the fastening block 70 engage with the male thread on the outer surface of the vertical plate 7002.

Now, a method to use the electronic device's-side connector 10 and the accessory's-side connector 40 will be described.

When mounting the accessory 200 on the video camera 100, the lid 114 is removed to expose the electronic device's-side connector 10 to the outside of the case 102.

As shown in FIGS. 14 and 15, the top face 5006 of the accessory's-side connector 40 is made to face the intermediate face 1207 of the electronic device's-side connector 10. Further, the first latch piece 5002 of the accessory's side-connector 40 is made to face the first concave portion 2002 of the electronic device's-side connector 10. Still further, the second latch piece 5004 of the accessory's-side connector 40 is made to face the second concave portion 2006 of the electronic device's-side connector 10. In this state, the shaft unit 50 of the accessory's-side connector 40 is inserted in the guide groove 18 of the electronic device's-side connector 10. Accordingly, accessory guide faces 54 on both the sides of the accessory's-side connector 40 come in contact with the connector's-side guide faces 24 so that the positioning of the accessory's-side connector 40 in the width direction of the guide groove 18 in the void space 22 is made.

According to such insertion of the accessory's-side connector 40, as shown in FIG. 12, the first latch piece 5002 of the accessory's-side connector 40 passes through the first concave portion 2002 and is positioned in the void space 22, and the second latch piece 5004 passes through the second concave portion 2006 and is positioned in the void space 22. Further, the top face 5006 of the accessory's-side connector 40 comes in contact with the intermediate face 1207 of the electronic device's-side connector 10, and the spring piece 52 of the accessory's-side connector 40 is positioned inside the first concave portion 2002.

Then, as shown in FIG. 13, when the shaft unit 50 is moved in the mounting direction, as the shaft unit 50 moves in the mounting direction, the spring piece 52 comes elastically in contact with the top of the first convex portion 2004 and is slightly buried in the side face of the shaft unit 50 and, while being elastically in contact with the top of the first convex portion 2004, moves together with the shaft unit 50.

Then, while the first and second latch pieces 5002 and 5004 being positioned on the undersurfaces of the first and second convex portions 2004 and 2008, the spring piece 52 protrudes into the second concave portion 2006. The erected face 60 of the accessory's-side connector 40 comes in contact with the contact face 1210 of the electronic device's-side connector 10, and the positioning in the mounting direction is made. In the present embodiment, while the first and second latch pieces 5002 and 5004 are being positioned on the undersurfaces of the first and second convex portions 2004 and 2008, the spring piece 52 is elastically in contact with the end of the second concave portion 2006 closer to the first convex portion 2004.

Then, according to the movement of the shaft unit 50 in the mounting direction, the cover 26 of the electronic device's-side connector 10 is moved to the open position by the erected face 60 of the accessory's-side connector 40. Further, after the contact strips 48 of the accessory's-side connector 40 having slidably contacted with the slope 1204 and the contact-strip attaching face 1206, they are connected to the contact strips 16 of the electronic device's-side connector 10 respectively to produce electrical continuity therebetween.

Then, when the operating ring 44 is rotated, the fastening block 70 moves downward, the move-prohibiting member 7006 is inserted into the concave portion 2006 between the first and second convex portions 2004 and 2008, thereby the shaft unit 50 is prohibited from moving along the direction in which the guide groove 18 extends.

Also, as the fastening block 70 moves downward, as shown in FIGS. 16 and 17, the first and second latch pieces 5002 and 5004 come in contact with the undersurfaces of the first and second convex portions 2004 and 2008. Further, the undersurfaces of the fastening parts 7004 come in contact with the first and second convex portions 2004 and 2008, and in collaboration with the first and second latch pieces 5002 and 5004, the fastening parts 7004 fasten the first and second convex portions 2004 and 2008 so that the accessory 200 is mounted on the video camera 100.

Thus, both the picture taking by the accessory 200 and the picture taking by the video camera can be performed at the same time. Further, an image signal produced in the accessory 200 is transmitted to the video camera 100 through the electronic device's-side connector 10 from the accessory's-side connector 40. In the video camera 100, necessary signal processing is applied to the transmitted image signal.

When removing the accessory 200 from the video camera 100, the fastening block 70 is moved upward by rotating the operating ring 44. Further, the move-prohibiting part 7006 is removed upward from the first concave portion 2006, the fastening part 7004 is moved upward, and the fastening of the first and second convex portions 2004 and 2008 with the collaboration of the first and second latch pieces 5002 and 5004 is released.

When the shaft unit 50 of the accessory's-side connector 40 is moved in the detaching direction, the first and second latch pieces 5002 and 5004 are moved while being in the void space 22, the first latch piece 5002 is positioned below the first concave portion 2002, the second latch piece 5004 is positioned below the second concave portion 2004, the spring piece 52 is elastically in contact with the tip of the first convex portion from the second concave portion and is slightly buried in the side surface of the shaft unit 50, moves together with the shaft unit 50 while being elastically in contact with the tip of the first convex portion 2004, and protrudes into the first concave portion 2002. When the shaft unit 50 moves in the detaching direction, each contact strip 48 of the accessory's-side connector 40 and each contact strip 16 of the electronic device's-side connector 10 are separated so as to release the electric continuity, and the cover 26 is returned to the close portion from the open position.

In this state, when the shaft unit 50 of the accessory's-side connector 40 is moved in the detaching direction, the first latch piece 5002 of the accessory's-side connector 40 passes through the first concave portion 2002, the second latch piece 5004 passes through the second concave portion 2006 to be moved upward from the void space 22, the shaft unit 50 of the accessory's-side connector 40 is separated from the electronic device's-side connector 10, and the accessory 200 is removed from the video camera 100.

With the above construction, when attaching the accessory's-side connector 40 to the electronic device's-side connector 10, the first latch piece 5002 of the accessory's-side connector 40 passes through the first concave portion 2002 and the second latch piece 5004 passes through the second concave portion 2006 to be positioned in the void space 22. Then, the first latch piece 5002 is positioned on the undersurface of the first convex portion 2004 by moving the shaft unit 50 of the accessory's-side connector 40 in the mounting direction, and with the second latch piece 5004 being positioned on the undersurface of the second convex portion 2008, the plurality of contact strips 40 of the electronic device's-side connector 10 comes in contact with the plurality of contact strips 16 of the electronic device's-side connector 10.

Now, let us consider the size S in the mounting direction of the space necessary for attaching the accessory's-side connector 40 to the electronic device's-side connector 10. In the present embodiment, the length of the first and second latch pieces 5002 and 5004 in the mounting direction is about one third of the size of the shaft unit 50 in the mounting direction. Therefore, the size S can be the sum of the size of the accessory's-side connector 40 in the mounting direction (the size of the shaft unit 50) L and the size of the first and second latch pieces 5002 and 5004 in the mounting direction, which is about L/3. In other words, the size S needed is about the sum of L and L/3.

In other words, the space necessary for attaching the accessory's-side connector 40 to the electronic device's-side connector 10 can be provided by the sum of the size of the accessory's-side connector 40 in the mounting direction and the size of the second latch piece 5004 in the mounting direction.

On the other hand, when attaching the accessory's-side connector 40 from the outside of a contour of the electronic device's-side connector 10 as in a conventional method, the size S has to be 2 L, which is twice as large as the size L of the accessory's-side connector 40 in the mounting direction.

Therefore, unlike the conventional method, it is not necessary to make much room around the electronic device's-side connector 10 for attaching the accessory's-side connector 40, which is quite advantageous when manufacturing smaller video cameras 100 and accessories 200. Further, it is quite advantageous for improving the design-wise quality of the video cameras 100 and the accessories 20.

Further, by rotating the operating ring 44, the fastening parts 7004 come in contact with the top faces of the first and second convex portions 2004 and 2008 and, in collaboration with the first and second latch pieces 5002 and 5004, fasten the first and second convex portions 2004 and 2008. Further, the move-prohibiting member 7006 is inserted into the first concave portion 2006 between the first and second convex portions 2004 and 2008 to prohibit the shaft unit 50 from moving along the direction in which the guide groove 18 extends. Therefore, the accessory's-side connector 40 can securely be attached to the electronic device's-side connector 10.

Thus, even when the external force along the extending direction of the guide groove 18 is applied to the accessory's-side connector 40, the accessory's-side connector 40 is advantageously prevented from falling off the electronic device's-side connector 10.

Further, the first convex portion 2004 of the electronic device's-side connector 10 engaged with the first latch pieces 5002 of the accessory's-side connector 40 and held between the first latch pieces 5002, namely, the convex portion 2004 for fixing the accessory's-side connector 40 is also used as a member to provide a click-like feeling with the spring piece 52 of the accessory's-side connector 40 elastically contacting it. Thus, increase in the number of parts can be suppressed, which is advantageous for reducing the costs.

Further, while the contact strips 48 of the accessory's-side connector 40 and the contact strips 16 of the electronic device's-side connector 10 being connected, the spring piece 52 is made to elastically contact the end portion of the first convex portion 2004 to tentatively hold the accessory's-side connector 40. Therefore, the first convex portion 2004 for fixing the accessory's-side connector 40 can also be utilized as a member for tentatively hold the accessory-side connector 40, which is advantageous for suppressing the increase in the number of parts and reducing the costs.

Now, the accessory's-side connector 40, which is a substantial part of the present invention, will be described.

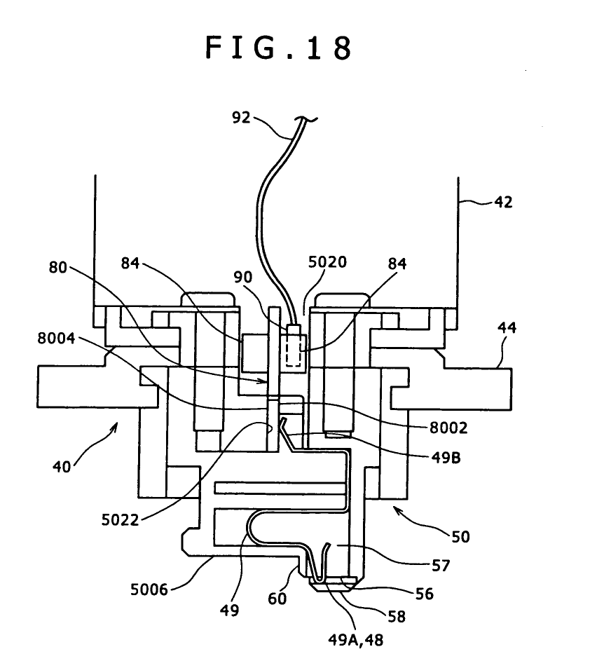

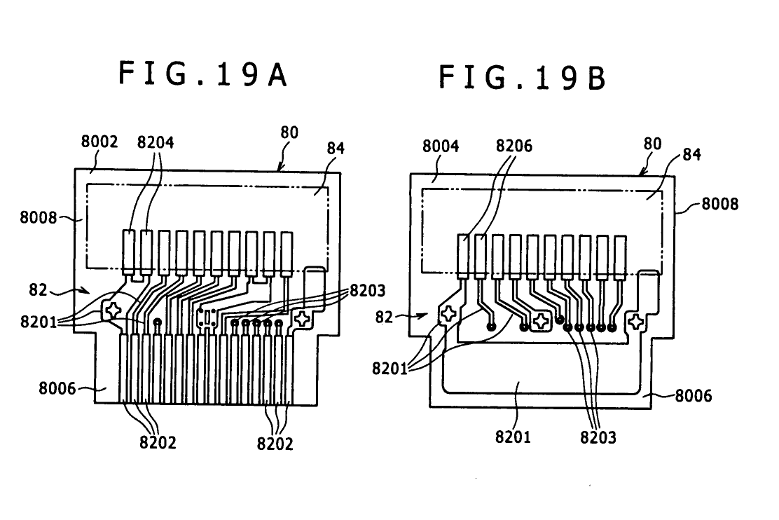

FIG. 18 shows a construction of the accessory's-side connector 40; FIG. 19A is a plan view showing one face of the intermediary substrate; and FIG. 19B is a plan view showing the other face of the intermediary substrate.

As shown in FIG. 18, the accessory's-side connector 40 includes a shaft unit 50 and a plurality of contact strips 48. Each contact strip 48 is constructed such that a plurality of leads 49 is exposed on the shaft unit 50.

Further, in the present embodiment, the rectangular case 202 serving as an armor corresponds to a case defined in claims of the present invention, and the shaft unit 50 corresponds to a connector case in the claims.

To describe in detail, each lead 49 is made of a narrow and long metal strip, and a portion of each lead 49 is imbedded in the shaft unit 50.

Each contact strip 48 is constructed such that the bent portion 49A of one end of each lead 49 protrudes downward (in the extending direction of the shaft unit 50 or the insertion direction) from the contact-strip attaching face 56. In a portion of the shaft unit 50 where each contact strip 48 is disposed, a void space 57 is provided so that the contact strips 48 can elastically be deformed.

The contact strips 48 of the accessory's-side connector 40 are provided on the contact-strip attaching face 56, and are arranged linearly at intervals in the direction of the pair of guide walls 58.

The contact strips 48 extend lineally on the contact-strip attaching face 56 at predetermined intervals in parallel with each other, aligned in a row.

As shown in FIGS. 7 and 8, the contact strips 48 include ground contact strips 4802 connected to ground and other signal contact strips 4804. The ground contact strip 4802 is connected to the ground contact strip 1602 of the electronic device's-side connector 10, and other signal contact strips 4804 are connected to other signal contact strips 1602 of the electronic device's-side connector 10.

As shown in FIG. 18, in the upper portion of the shaft unit 50, a housing space 5020 is formed which is opened to the shaft member 42 (opened upward). At the bottom of the housing space 5020, an insertion groove 5022 for an intermediary substrate is formed facing the housing space 5020.

The other end 49B of each lead 49 is provided so that it is exposed to the side portion of the intermediary-substrate insertion groove 5020 provided in the shaft unit 50.

As shown in FIG. 19, the intermediary substrate 80 is provided inside the shaft unit 50, and the intermediary substrate's-side connector 84 is built in the intermediary substrate 80.

In the present embodiment, the intermediary substrate 80 has the first and second faces 8002 and 8004 on both the sides in its thickness direction. The wiring patterns 82 are provided on both the first and second faces 8002 and 8004.

The intermediary substrate's-side connectors 84 also are connected to those wiring patterns 82 and are provided on both the first and second faces 8002 and 8004.

Inside the shaft unit 50, an electronic circuit's-side connector 90 connected to the electronic circuit through the wire 92 is provided. The electronic circuit and the accessory's-side connector 40 are electrically connected when the electronic circuit's-side connector 90 and the intermediary substrate's-side connector 84 are connected inside the shaft unit 50.

To be specific, the intermediary substrate 80 is, as shown in FIG. 19, substantially rectangle.

The intermediary substrate 80 has a narrow first region 8006 which is made by cutting away both the end portions of one of the long sides and a second region 8008, whose width is wider than that of the first region 8006, provided on the other long side.

The intermediary substrate 80 is positioned with the first region 8006 inserted into the intermediary-substrate inserting groove 50.

As shown in FIG. 19A, in the first region 8006 of the first face 8002 of the intermediary substrate 80, a plurality of first contact strips 8202 for connection extending in the direction perpendicular to the above one long side is formed. In the present embodiment, 16 contact strips 8202 are formed.

The first contact strips 8202 for connection of the intermediary substrate 80 are formed at the same intervals as those of the contact strips 48 in the direction in which the above one long side extends, and are electrically connected to respective contact strips 48 with the first region 8006 being inserted into the intermediary-substrate inserting groove 50.

As shown in FIG. 19A, in the second region 8008 of the first face 8002 of the intermediary substrate 80, a plurality of second contact strips 8206 for connection (in the present embodiment, 10) connected to the first contact strip 8202 for connection through a conductor pattern 8201 extending in the direction perpendicular to the other long side are formed at longer intervals than those of the first contact strips 8202 for connection.

In the second region 8008 of the intermediary substrate 80, the intermediary substrate's-side connector 84 is attached by soldering etc. and the second contact strips 8204 for connection and the intermediary substrate's-side connector 84 are electrically connected.

As shown in FIG. 19B, also in the second region 8008 of the second face 8004 of the intermediary substrate 80, there is provided a plurality of third contact strips 8206 for connection (in the present embodiment, 10) connected to the first contact strips 8202 for connection through the conductor pattern 8201 and through holes 8203, and extending in the direction perpendicular to the other long side at the longer intervals than those of the first contact strips 8202 for connection in the direction in which the other long side extends. In the present invention, they are formed at the same intervals as those of the second contact strips 8204 for connection.

To each of the third contact strip 8206 for connection of the intermediary substrate 80, the intermediary substrate's-side connector 84 is attached by soldering etc. and the third contact strips 8206 for connection and the intermediary substrate's-side connector 84 are electrically connected.

In the present embodiment, the wiring pattern 82 includes the first, second, and third contact strips 8202, 8204, and 8206 for connection, the conductor pattern 8201, and the through holes 8203.

According to the present embodiment, since the portion of the intermediary substrate 80 where the intermediary substrate's-side connector 84 is provided is away from the contact strips 48 of the accessory 200, a space of the intermediary substrate 80 occupied by the intermediary substrate's-side connector 84 can sufficiently be secured. Therefore, even when numbers of contact strips 48 are provided in a limited space, the contact strips 48 can be connected to the electronic circuit of the accessory 200 reliably, which is advantageous for coping with the increase in the number of signals sent and received between the accessory 200 and the video camera 100.

In the present embodiment, the case where the accessory 200 is a small-sized camera has been described. However, when there are a lighting device (video light), a microphone, etc. as accessories 200 in addition to the small-sized camera, the accessory's-side connector 40 can be shared by them. For example, the intermediary substrate 80 can accommodate a plurality of accessories 200 if one of the two intermediary substrate's-side connectors 84 provided on the intermediary substrate 80 is assigned to a signal corresponding to one of the small-sized camera, lighting device, and microphone, and the other of the intermediary substrate's-side connectors 84 is assigned to a signal corresponding to one of the remaining small-sized camera, lighting device, and microphone. With this construction, the accessory's-side connector 40 can be shared, which is advantageous for reducing the costs of parts and the assembling cost of such parts.

Further, it is needless to say that, of the two intermediary substrate's-side connectors 84, the one which is not used can be omitted.

Also, when the number of signals sent and received between the electronic circuit of the accessory 200 and the video camera 100 is further increased, if the accessory has two functions of a lighting device and a microphone, for example, two intermediary substrate's-side connectors 84 may be provided on the intermediary substrate 80 to correspond to the number of signals sent and received between the electronic circuit of the accessory 200 and the video camera 100. Further, two accessory's-side connectors 90 may be provided, and those two intermediary substrate's-side connectors 84 and the accessory's-side connectors 90 may be connected, respectively.

### Second Embodiment

Now, a second embodiment 2 of the present embodiment will be described.

In the second embodiment, a case where the accessories 200 are a microphone for collecting 4-channel sounds and a lighting unit will be described.

Now, the signals sent and received between the electronic circuit of the accessory 200 and the video camera 100 will specifically be described.

When the accessory 200 is a microphone for collecting four-channel sounds, there exist ten kinds of signals in all, namely, signals for the power supply (UNREG), ground (GND), two exclusive resistance-connecting (connection) terminals (ID1) and (ID2) for the video camera 100 to identify accessories 200, an audio signal (MicFL) of front left, an audio signal (MicFR) of front right, an audio signal (MicRL) of rear left, an audio signal (MicRR) off rear right, a signal for ground (GND) exclusively used for a microphone, and a control signal (Shoe Cont) for the video camera 100 to control the accessory 200.

Further, when the accessory 200 is a lighting unit, there exist eight kinds of signals in all, namely, signals for the power supply (UNREG), ground (GND), two exclusive resistance-connecting (connection) terminals (ID1) and (ID2) for the video camera 100 to identify accessories 200, a signal (Strobo) for synchronously firing a flash, a bi-directional serial signal (Serial 0) for setting a level (quantity of light) of the flash, and signals (Serial 1 and Serial 2) which can be assigned to data signals for serial high-speed communications such as USB and IEEE 1394.

Thus, when the microphone and the lighting unit share the accessory's-side connector 40, eighteen kinds of signals in all have to be transmitted. However, since power supply (UNREG) and ground (GND) can be shared, it serves the purpose if sixteen signals in all are transmitted. Therefore, sixteen first contact strips 8202 for connection may be sufficient.

Further, when the accessory's-side connector 40 is shared by the microphone and the lighting unit, in the present embodiment, ten second contact strips 8204 for connection or third contact strips 8206 for connection of the intermediary substrate 80 are provided. Since only eight kinds of signals have to be transmitted when the accessory 200 is a lighting unit, either two of the second contact strips 8204 for connection or two of the third contact strips 8206 for connection remain unused.

However, when relatively strong current flows as in the case of the lighting unit, if two terminals of the power supply (UNREG) and two terminals of the ground (GND) are each assigned, it is advantageous for reducing the resistance values at the wiring pattern 82 of the intermediary substrate 80, intermediary substrate's-side connector 84, and accessory's-side connector 90, and also for securing current capacity.

In the present embodiment, the case where the electronic device on which the accessory 200 is mounted is the (a) video camera. However, electronic devices on which accessories according to embodiments of the present invention are mounted are not limited to the above. It is needless to say that they may be various kinds of electronic devices such as a personal digital assistant (PDA) equipped with a camera, a portable telephone equipped with a camera, or various kinds of image pick-up devices like a digital still camera and a film-based camera.

It should be understood by those skilled in the art that various modifications, combinations, sub-combinations and alterations may occur depending on design requirements and other factors insofar as they are within the scope of the appended claims or the equivalents thereof.

1-6. (canceled)

7. An accessory detachably mounted on an electronic device, comprising:
a case;
an electronic circuit housed in the case for activating the accessory;
an accessory side connector for supplying power to the electronic circuit and sending and receiving signals;
an electronic circuit side connector connected to the electronic circuit;
an intermediary substrate having a wiring pattern provided inside the case; and
a plurality of contact strips and a plurality of leads connected to the wiring pattern on the intermediary substrate,
wherein the intermediary substrate includes an intermediary substrate side connector connected to the wiring pattern,
wherein the electronic circuit is electrically connected to the accessory side connector when the electronic circuit side connector is connected to the intermediary substrate side connector, and
wherein the accessory side connector has first and second latch pieces and a protruded spring piece between the first and second latch pieces on side faces of the accessory side connector.

8. The accessory according to claim 7, wherein the case includes a case body and a connector case, the case body housing the electronic circuit and the connector case having a portion of the plurality of leads embedded therein and attached to the case body, and
wherein the intermediary substrate and the intermediary substrate side connector are provided in the connector case.

9. The accessory according to claim 8, wherein the electronic circuit side connector is connected to the intermediary substrate side connector inside the connector case.

10. The accessory according to claim 7, wherein the intermediary substrate includes two opposing side faces in a thickness direction thereof, wherein the wiring pattern is provided on the two opposing side faces of the intermediary substrate, respectively, and
wherein the intermediary substrate side connector is connected to the wiring pattern provided on the two opposing side faces of the intermediary substrate.

11. The accessory according to claim 7, wherein the wiring pattern includes a plurality of first contact strips connected to the plurality of leads and a plurality of second contact strips connected to the intermediary substrate side connector,
wherein the intermediary substrate includes first and second linearly extending sides,
wherein the plurality of first contact strips are disposed in intervals along the first side of the intermediary substrate, and
wherein the plurality of second contact strips are disposed in intervals longer than the intervals of the first contact strips along the second side of the intermediary substrate.

12. The accessory according to claim 7, wherein the wiring pattern includes a plurality of first contact strips connected to the plurality of leads and a plurality of second contact strips connected to the intermediary substrate side connector,
wherein the intermediary substrate is rectangular and includes first and second long sides,
wherein the plurality of first contact strips are disposed in intervals on the first long side of the intermediary substrate, and
wherein the plurality of second contact strips are disposed on the second long side of the intermediary substrate in longer intervals than those of the first contact strips.
